(19) United States
(12) Patent Application Publication
(10) Pub. No.: US 2015/0365857 A1
(43) Pub. Date: Dec. 17, 2015

(54) MEASUREMENTS IN MULTIPLE CONNECTION SYSTEMS

(71) Applicants: Na WEI, Beijing (CN); Pengfei SUN, Beijing (CN); Lili ZHANG, Beijing (CN); Wei BAI, Beijing (CN); Jing HAN, Beijing (CN); Xinying GAO, Beijing (CN); Haiming WANG, Beijing (CN)

(72) Inventors: Na WEI, Beijing (CN); Pengfei SUN, Beijing (CN); Lili ZHANG, Beijing (CN); Wei BAI, Beijing (CN); Jing HAN, Beijing (CN); Xinying GAO, Beijing (CN); Haiming WANG, Beijing (CN)

(73) Assignee: BROADCOM CORPORATION, Irvine, CA (US)

(21) Appl. No.: 14/761,495

(22) PCT Filed: Jan. 18, 2013
(86) PCT No.: PCT/CN2013/070702

§ 371 Date: Jul. 16, 2015

(51) Int. Cl. H04W 36/00; H04W 24/10

(52) U.S. Cl. CPC H04W 36/0083; H04W 24/10; H04W 84/12

(57) ABSTRACT

Systems and techniques for link condition reporting in multiple connection systems. A base station, such as a macro eNodeB (eNB) configures measurement objects and reporting objects for macro and local area links for a user device such as a user equipment (UE). The objects relating to the secondary links are configured for use when the user device is operating in a dual connection mode. Upon detection of a triggering event when the user device is in dual connection mode, the user device reports macro and secondary link information. In some embodiments of the invention, triggering may be based on events related to a specified frequency group, or may be direct measurements related to a specified frequency group.

### TECHNICAL FIELD

The present invention relates generally to wireless communication. More particularly, the invention relates to mechanisms for managing measurements for multiple connection systems.

### BACKGROUND

As the number of mobile communication devices continues to increase and as new applications for their use continue to be developed, the consumption of data communication resources increases apace. Service providers are constantly endeavoring to increase the data communication capacity they can provide while managing their infrastructure costs. As the demand for data communication services continues to increase, systems come nearer to reaching the capacity of the available communication spectrum. If the capacity of the communication spectrum in an area, such as a wireless network cell, is reached, the addition of infrastructure will not increase the data communication capacity of a service provider maintaining the cell. Therefore, service providers are constantly seeking to increase the efficiency of their communication spectrum usage and to identify new portions of the communication spectrum that can be used.

### SUMMARY

In one embodiment of the invention, an apparatus comprises at least one processor and memory storing computer program code. The memory storing the computer program code is configured to, with the at least one processor, cause the apparatus to at least configure a measurement object information element for a primary link with a user device served by a primary base station of a wireless network, configure a measurement object secondary link for a secondary base station with the user device upon establishment by the user device of a dual connection mode wherein the user device is served by the primary base station and the secondary base station, and receive link information relating to the secondary link reported by the user device in a secondary link measurement object in response to occurrence of a triggering event while the user device is operating in the dual connection mode.

In one embodiment of the invention, an apparatus comprises at least one processor and memory storing computer program code. The memory storing the computer program code is configured to, with the at least one processor, cause the apparatus to at least receive configuration information for a measurement object information element for a primary link with a user device served by a primary base station of a wireless network, receive configuration information for a secondary link measurement object for a secondary base station with the user device upon establishment by the user device of a dual connection mode wherein the user device is served by the primary base station and the secondary base station, and control the user device to use the secondary link measurement object to report link information relating to the secondary link in response to occurrence of a triggering event while the user device is operating in the dual connection mode.

In another embodiment of the invention, a method comprises configuring a measurement object information element for a primary link with a user device served by a primary base station of a wireless network configuring a measurement object secondary link for a secondary base station with the user device upon establishment by the user device of a dual connection mode wherein the user device is served by the primary base station and the secondary base station, and receiving link information relating to the secondary link reported by the user device in a secondary link measurement object in response to occurrence of a triggering event while the user device is operating in the dual connection mode.

In another embodiment of the invention, a method comprises receiving configuration information for a measurement object information element for a primary link with a user device served by a primary base station of a wireless network, receiving configuration information for a measurement object secondary link for a secondary base station with the user device upon establishment by the user device of a dual connection mode wherein the user device is served by the primary base station and the secondary base station and controlling the user device to use a secondary link measurement object to report link information relating to the secondary link in response to occurrence of a triggering event while the user device is operating in the dual connection mode.

In another embodiment of the invention, a computer readable medium stores a program of instructions. Execution of the program of instructions by a processor configures an apparatus to at least configure a measurement object information element for a primary link with a user device served by a primary base station of a wireless network, configure a measurement object secondary link for a secondary base station with the user device upon establishment by the user device of a dual connection mode wherein the user device is served by the primary base station and the secondary base station, and receive link information relating to the secondary link reported by the user device in a secondary link measurement object in response to occurrence of a triggering event while the user device is operating in the dual connection mode.

In another embodiment of the invention, a computer readable medium stores a program of instructions. Execution of the program of instructions by a processor configures an apparatus to at least receive configuration information for a measurement object information element for a primary link with a user device served by a primary base station of a wireless network, receive configuration information for a secondary link measurement object for a secondary base station with the user device upon establishment by the user device of a dual connection mode wherein the user device is served by the primary base station and the secondary base station, and control the user device to use the secondary link measurement object to report link information relating to the secondary link in response to occurrence of a triggering event while the user device is operating in the dual connection mode.

### BRIEF DESCRIPTION OF THE DRAWINGS

FIG. 1 illustrates wireless network according to an embodiment of the present invention;

FIG. 2 illustrates a process according to an embodiment of the present invention; and

FIG. 3 illustrates elements according to an embodiment of the present invention.

### DETAILED DESCRIPTION

One or more embodiments of the present invention recognize that a promising mechanism for increasing communication efficiency is multiple connection system. A geographic area may, for example, be served by a macro base station, such as a macro eNodeB (eNB) and a local area (LA) base station, so that a user device, such as a user equipment (UE) may lie within an area served by a macro eNB defined by the macro eNB, and an area served by a local area eNB. More than one local area eNB may be present in the vicinity of a macro eNB and a user equipment may lie within areas served by multiple eNBs while maintaining a connection with a macro eNB and with multiple local area base stations.

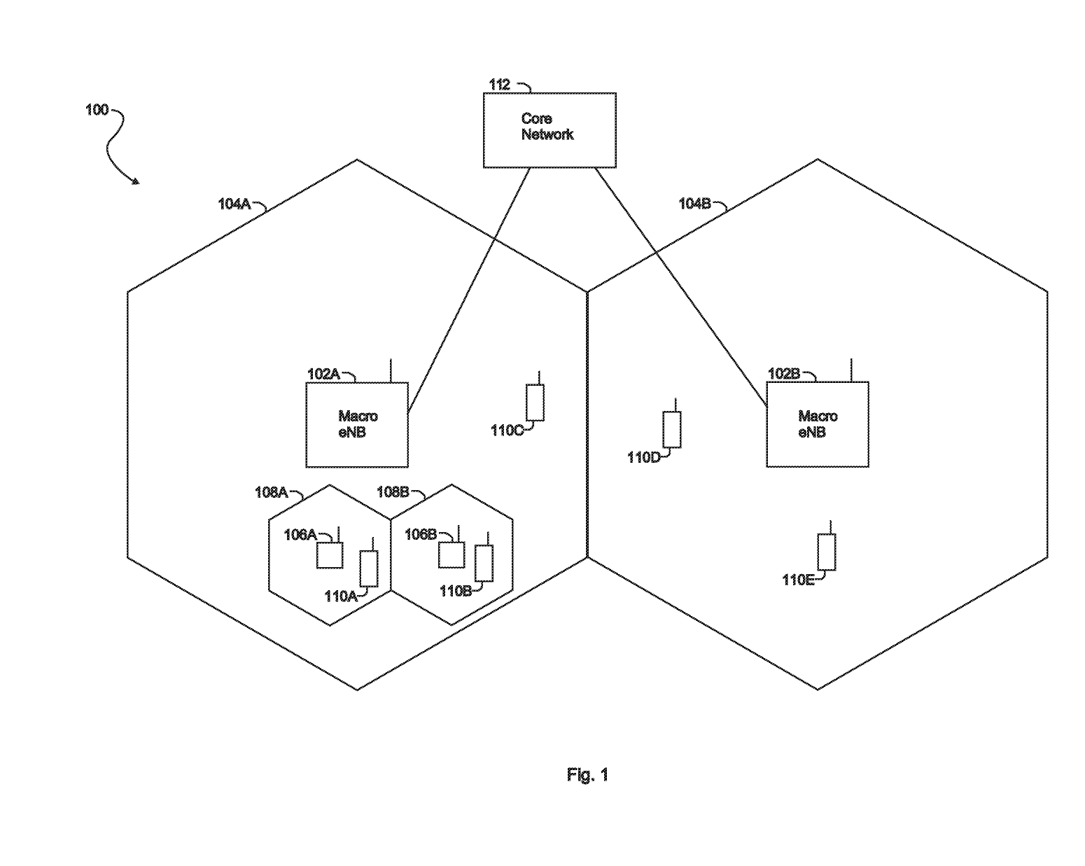

FIG. 1 illustrates a network 100 according to an embodiment of the present invention. The network 100 is presented here with elements and characteristics of a system such as one adhering to third generation preferred partnership long term evolution (3GPP LTE) or 3GPP LTE-advanced (3GPP LTE-A) standards, but it will be recognized that such a presentation is exemplary only and that one or more embodiments of the invention apply generally to measurement reporting in a wireless system with two links operating simultaneously.

The network 100 comprises a plurality of macro base stations, which in an embodiment may suitably be implemented as macro eNodeBs (eNBs) 102A and 102B. The macro eNB 102A defines a macro cell 104A (possibly with multiple carriers in aggregation) and the macro eNB 102B defines a macro cell 104B. The network 100 further comprises local area base stations 106A and 106B, lying within the macro cell 104A and defining local area cells 108A and 108B, respectively, which may be wholly or partly contiguous with the macro cell 104A. For simplicity, the present example does not describe local area eNBs serving areas contiguous with that served by the macro eNB 104B, but it will be recognized that many different combinations of macro eNBs and local area eNBs can be expected to be deployed throughout a network.

The network 100 serves a plurality of user devices, here presented as user equipments (UEs) 110A-110E. The base stations 102A, 102B, 106A, and 106B may communicate with a core network 112. The network 100 may employ dual connection or multiple connections, providing for connection by the macro eNB 102A, as well as one or more of the local area base stations, configured as local area eNBs, or LA eNBs, 106A and 106B. For example, the UE 110A may be connected to the eNB 102A, and the LA eNB 106A, and may therefore lie within the cell 104A and the cell 108A. The eNB 102A and the eNB 106A may be serving eNBs for the UE 110A, with the eNB 102A being a primary eNB and the eNB 106A being a secondary eNB. In one exemplary embodiment, the macro eNB 102A provides mobility services for the UE 110A and the local area eNB 106A provides data services. Local area eNBs may conveniently be implemented using 3.5 GHz frequencies, while macro eNBs are more commonly implemented using 2 GHz frequencies. 3.5 GHz frequencies commonly provide up to 100 MHz continuous frequency resources, and can provide for a reduced power consumption because of a better channel quality to a local area eNB with a low path loss. Such a higher channel quality can improve spectrum efficiency by providing for a higher re-use factor.

In the present example, as noted above, the UE 110A is connected to the eNB 102A, so that the eNB 102A has a macro link with the UE 110A. The UE 110A is also connected to the LA eNB 106A, so that the LA eNB 106A has a local area link, or LA link, with the UE 110A.

In a dual connection case, particularly a case in which the macro eNB is managing mobility services for the UE, it is advantageous for the macro eNB to perform measurement configuration on both the macro frequency and the local area frequency to support local area mobility. The macro eNB may configure local area link measurement events to assist measurement reporting. Embodiments of the present invention recognize that prior-art measurement events, designed for single connection, may not be applicable to dual connection. Such problems are particularly applicable to measurement events defined in 3GPP Technical Specification 36.331 Release 8 through Release 10, and may arise from confusion as to which link is the serving eNB, which reports targets to which link, and other issues.

Prior Art events may include:
Event A1 Serving cell quality exceeds a threshold
Event A2 Serving cell quality falls below a threshold
Event A3 Neighbor cell provides a quality better than that of a primary cell
Event A4 Neighbor cell quality exceeds a threshold
Event A5 Primary cell falls below a first threshold and neighbor cell exceeds a second threshold
Event A6 Neighbor cell quality exceeds the serving cell quality by an offset

Embodiments of the invention recognize that in a dual connection case, additional, extended, or different measurement events may be useful.

For example, a macro eNB may need to measure its own link conditions or local area link conditions. Measurement of a macro eNB's own link conditions may be accomplished using measurements and measurement triggers similar to events A1-A6 discussed above. However, in the case of event A3 it will be desirable to avoid an unnecessary link report even if the local area link is of a higher quality than is the macro link, because the local area link will be connected and may perform its own reports.

If the local area link is worse than the threshold, a measurement may be triggered in a manner similar to the event A2, with the event being triggered by the local area link.

If the neighbor to the local area eNB (considering only frequencies used for local area eNBs) is better than the local serving link, a measurement may be desirable. It is desirable to trigger a measurement only based on the local area frequencies in order to avoid unnecessary reporting on the macro link because that information is provided by the macro eNB's own measurements.

In one or more embodiments of the invention, therefore, measurement configuration and reporting of dual connection is accomplished, using information elements defined for a secondary link (that is, the link other than the link configuring the measurement object. To reduce redundant reporting of events A3, A4, and A5, listed above, in dual connection, one or more embodiments of the invention define rules depending on predefined frequency groups and dual connection mode status. In the following discussion it is assumed that a UE will perform a measurement report to the macro eNB or LA eNB according to which the eNB configures the measurement object. The UE reports its measurements to the LA eNB if the LA eNB configures the measurement object, and the UE reports its measurements to the macro eNB if the macro eNB configures the measurement object.

To enable independent measurement objects for dual connection scenarios (even with carrier aggregation on each link), new information objects for secondary link measurement object and measurement results should be defined as follows. An information element (IE) MeasObject is configured by an eNB, such as the eNB 102A, for a macro link. According to one or more embodiments of the invention, elements of the network 100, such as the LA eNB 104A and the UE 110A use an IE defined as MeasObjectSecondaryLink and an eNB such as the LA eNB 104A may configure MeasObjectSecondaryLink for an LA link after establishment of a dual connection mode. In one or more embodiments of the invention, the IE MeasObjectSecondaryLink inherits the content IEs from MeasObject of the extended universal terrestrial radio access network (EUTRAN).

A UE such as the UE 110A will perform two measurement objects separately for two links. It may, for example, consider a Macro eNB's PCell/SCell(s) events in MeasObject, and consider an LA eNB's PCell/SCell(s) events in MeasObjectSecondaryLink.

One or more embodiments of the invention also define an IE MeasResultsSecondaryLink, and a UE such as the UE 110A will make a report on a Macro eNB's PCell/SCell(s) with MeasResults and report on LA eNB's PCell/SCell(s) with MeasResultsSecondaryLink.

In one or more embodiments of the invention, MeasObjectSecondaryLink and MeasResultsSecondaryLink are valid only when dual connection is established for a particular UE, and disabled when the UE is no longer operating in dual connection mode.

Embodiments of the invention further recognize that unneeded reporting is a waste of signaling resources, and that any wasting of signaling resources is to be avoided. In dual connection, if information on only one link is needed, only that link should be reported. To further address reporting redundancy issues for event A3, A4, and A5, embodiments of the invention define frequencies to be measured for events A3, A4, and A5 based on frequency groups and a UE operating mode, and define events for A3, A4, and A5 which consider a neighbor only in specified frequency groups dedicated to dual connection mode.

In one or more embodiments of the invention following discussion, frequency ranges may be defined as macro frequency ranges or LA frequency ranges, and may be signaled to a UE by appropriate signaling before a measurement object is signaled to the UE. For example, in the E-UTRAN operating bands, bands 1 and 5 may be allocated to a macro frequency group and band 42 may be defined as the LA frequency group.

Following are a number of examples of scenarios that may be addressed using one or more embodiments of the invention. Measurements are used to support mobility, so that implementation examples are discussed below for a number of typical mobility scenarios. In all examples, the macro eNB (in this case, the eNB 102A) configures MeasObject for the macro link and MeasObjectSecondaryLink for the LA link, and configures event A2 and A3 in both measurement objects. Such an approach allows the macro eNB to obtain measurement results from another link when in dual connection mode and perform more efficient mobility handling for LA eNBs. Such an approach also allows for support of carrier aggregation in both links.

In one scenario, the macro link is stable but the LA serving link is worse than a threshold and no neighbor LA is better than a threshold. In one scenario, for example, the macro link between the macro eNB 102A and the UE 110A is stable but the link between the LA 104A and the UE 110A is worse than a threshold and the quality of the LA 104B and the UE 110A is not better than a threshold. Such a case may occur, for example, if LA deployment is sparse and the UE is moving out of an LA eNB. In this case, the UE sends the report to the macro eNB, triggered by the secondary (LA) link's A2 event. No LA A3 event is triggered. The macro eNB 102A may trigger the UE 110A to release the LA connection and revert to a single connection.

In another scenario, the serving eNB (LA eNB 104A is worse than threshold, and the neighbor LA eNB (104B) is better than a threshold or offset better. Such a scenario may occur, for example, if LA deployment is dense and a UE is moving out of one LA eNB, and into another LA eNB's coverage. In this case, the UE 110A sends a report to macro eNB, is triggered by the secondary link's A2 and A3 events. Behavior: if the LA eNBs (for example, the eNB 108A and 108B) are within the same macro eNB (104A), then the macro eNB 102A can trigger LA eNB handover.

In another scenario, both the macro eNB and the LA eNB are worse than a threshold (for example, if the UE is moving out of the coverage of both the macro link and the LA link). The UE may report to the macro eNB, triggered by events A2 and A3 for both the macro link and the secondary LA link, or the UE sends reports to the macro eNB, triggered only by the macro link A2 and A3 events and the secondary LA link's A2 event. The response to such a scenario may be, for example, evaluation of a reconnection or handover of both the macro link and the LA link (dual connection transfer together) or only the reconnection/handover of the macro link (new single connection).

In another scenario, event A3 occurs for the macro link, that is, a neighbor cell becomes better than the primary cell by an offset. In the present example, the cell 104B becomes better than the cell 104A. The cell triggering the event is using the frequency indicated in the associated measObject IE, which may be different from the primary frequency used by the primary cell.

In one or more embodiments, the invention also provides mechanisms to prevent unnecessary A3, A4, and A5 events in dual connection mode. Such mechanisms are provided because A3 may be triggered if, as often occurs, the LA link quality is better than the macro link quality. However, the macro eNB does not need such reports in dual connection mode.

Although report redundancy can be mitigated by removing LA frequencies from cell lists for macro measurement objects, the macro eNB may suffer from receiving information relating to the LA link quality if the UE falls back to single connection mode. However, the UE may need to report LA link quality to a handover to LA eNB in case the macro link is broken. Embodiments of the invention therefore provide for measurements and measurement triggering events that take into account factors such as frequency groups and operating modes, particularly in cases in which the factors include conditions related to neighbor cells. In cases of dual connection, scenarios may occur in which a relevant neighbor may be a macro eNB or an LA eNB, but not both. Triggering a measurement of a neighbor for which no measurement is needed wastes resources.

If a UE is operating in single connection mode, the UE may measure and report all frequency groups configured for event A3. In one or more embodiments of the invention, therefore, measurements may be configured based on frequency groups and UE operating modes, particularly for events A3, A4, and A5. If the UE is operating in dual connection mode, the UE may measure and report frequencies for event A3, A4, and A5 which are identified as belonging to a macro frequency group.

The cell(s) that triggers the event may be operating using the frequency indicated in the associated measObject, and this frequency may be different from the (primary) frequency used by the PCell. For single connection or dual connection mode, the frequency list may include different frequency groups. In single connection mode, both the macro frequency group and the LA frequency group will be considered in measurement objects; for dual connection mode, only the macro frequency group is considered.

In addition, embodiments of the invention may define additional events, which may be labeled as A7, A8, and A9. Events A7, A8, and A9 may occur in dual connection mode, replacing A3, A4, and A5, which would occur in single connection mode. The events A7, A8, and A9 are as follows:

A7 Neighbor cell within a frequency group of the serving cell becomes better than serving cell within its own frequency group

A8 Neighbor cell within a frequency group of the serving cell becomes better than a threshold, by at least a predefined offset value.

A9 Primary cell becomes worse than threshold 1 and neighbor cell within the same frequency group becomes worse than threshold 2.

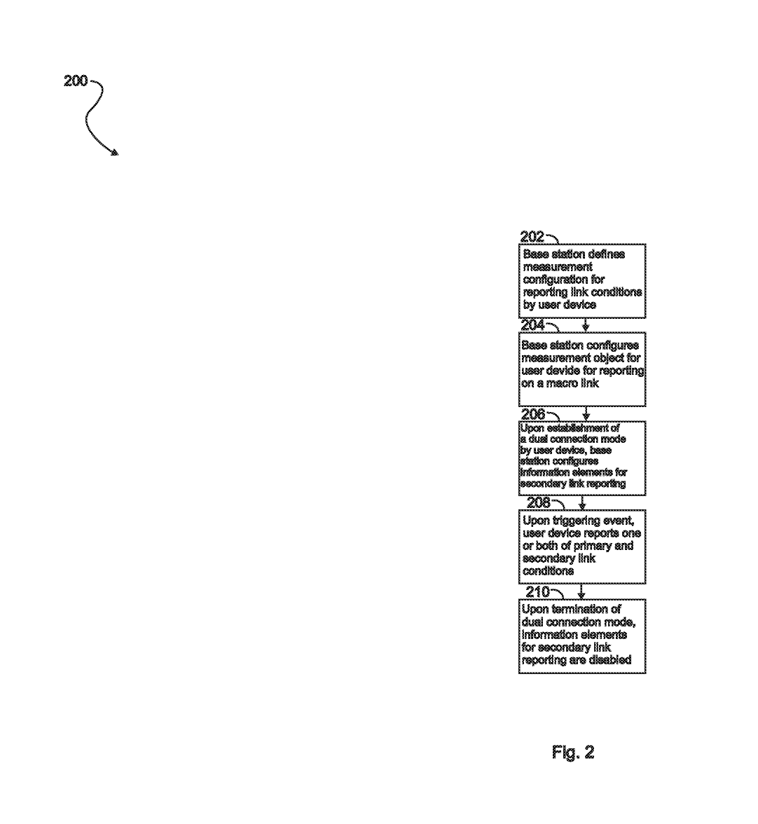

FIG. 2 illustrates a process 200 according to an embodiment of the invention. At step 202, a base station defines a measurement configuration for reporting of link conditions by a user device. The measurement configuration may comprise defining frequencies to be reported when the user device is in a dual connection mode, or may, alternatively or in addition, define triggering events to be used when the user device is in a dual connection mode, with the triggering events being based on conditions relating to neighbor cells in specified frequency groups. At step 204, the base station configures a measurement object for a user device for reporting on a macro link. At step 206, upon establishment of a dual connection mode by the user device, the base station configures one or more information elements for reporting on a secondary link, such as an information element for a secondary link measurement objects and for reporting secondary link measurement results. At step 208, upon a triggering event, such as the triggering events A1-A9 described above, the user device reports one or both of primary and secondary link conditions to the base station. At step 210, upon termination of a dual connection mode, information elements for secondary link reporting are disabled.

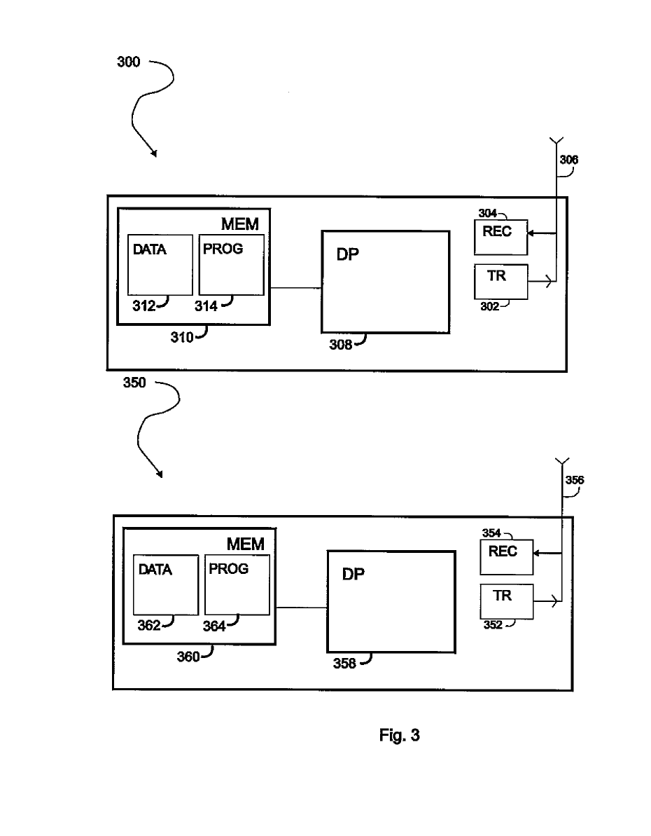

Reference is now made to FIG. 3 for illustrating a simplified block diagram of details of an exemplary device, here implemented as a user equipment (UE) 300 and eNB 350, suitable for wireless network communication, that may be used to carry out an embodiment of the invention.

The UE 300 includes a transmitter 302 and receiver 304, antenna 306, one or more data processors (DPs) 308, and memory (MEM) 310 that stores data 312 and one or more programs (PROG) 314. The eNB 350 includes a transmitter 352 and receiver 354, antenna 356, one or more data processors (DPs) 358, and memory (MEM) 360 that stores data 362 and one or more programs (PROG) 364.

At least one of the PROGs 314 and 364 is assumed to include program instructions that, when executed by the associated DP, enable the electronic devices to operate in accordance with the exemplary embodiments of this invention as was detailed above in detail.

In general, the exemplary embodiments of this invention may be implemented by computer software executable by the DP 306 or 356, or by hardware, or by a combination of software and/or firmware and hardware. The interactions between the major logical elements should be clear to those skilled in the art for the level of detail needed to gain an understanding of the broader aspects of the invention beyond only the specific examples herein. It should be noted that the invention may be implemented with an application specific integrated circuit ASIC, a field programmable gated array FPGA, a digital signal processor or other suitable processor to carry out the intended function of the invention, including a central processor, a random access memory RAM, read only memory ROM, and communication ports for communicating, for example, channel bits as detailed above.

In general, the various embodiments of the UE 300 can include, but are not limited to, mobile phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 310 and 360 may be of any type suitable to the local technical environment and may be implemented using any suitable data storage technology, such as semiconductor based memory devices, magnetic memory devices and systems, optical memory devices and systems, fixed memory and removable memory. The DP 308 may be of any type suitable to the local technical environment, and may include one or more of general purpose computers, special purpose computers, microprocessors, digital signal processors (DSPs) and processors based on a multi-core processor architecture, as non-limiting examples.

At least one of the memories is assumed to tangibly embody software program instructions that, when executed by the associated processor, enable the electronic device to operate in accordance with the exemplary embodiments of this invention, as detailed by example above. As such, the exemplary embodiments of this invention may be implemented at least in part by computer software executable by the controller/DP of the UE 300 or the eNB 350, or by hardware, or by a combination of software and hardware.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1-10. (canceled)

11. An apparatus comprising:
at least one processor;
memory storing computer program code;
wherein the memory storing the computer program code is configured to, with the at least one processor, cause the apparatus to at least:
receive configuration information for a measurement object information element for a primary link with a user device served by a primary base station of a wireless network;
receive configuration information for a secondary link measurement object for a secondary base station with the user device upon establishment by the user device of a dual connection mode wherein the user device is served by the primary base station and the secondary base station; and
control the user device to use the secondary link measurement object to report link information relating to the secondary link in response to occurrence of a triggering event while the user device is operating in the dual connection mode.

12. The apparatus of claim 11, wherein the memory storing the computer program code is further configured to, with the at least one processor, cause the apparatus to limit the user device to measuring frequencies within at least one defined frequency group, upon occurrence of a triggering event when the user device is in a dual connection mode.

13. The apparatus of claim 11, wherein the memory storing the computer program code is further configured to, with the at least one processor, cause the apparatus to control the user device, when the user device is operating in a dual connection mode, to report link information upon the recognition of a triggering event relating to at least one frequency in at least one specified frequency group.

14. The apparatus of claim 11, wherein the primary link is a link between a user device and a macro base station and the secondary link is a link between a user device and a local area base station.

15. The apparatus of claim 11, wherein the primary link is a link between a user device and a local area base station and the secondary link is a link between a user device and a macro base station.

16. The apparatus of claim 11, wherein the apparatus is configured to operate III a third generation preferred partnership long term evolution wireless system.

17. The apparatus of claim 11, wherein the apparatus is configured to operate in a third generation preferred partnership long term evolution—advanced wireless system.

18. The apparatus of claim 11, wherein the user device is a mobile phone.

19. The apparatus of claim 11, wherein the device is a user equipment.

20. The apparatus of claim 2111, wherein the user equipment is a mobile phone.

21-28. (canceled)

29. A method comprising:
receiving configuration information for a measurement object information element for a primary link with a user device served by a primary base station of a wireless network;
receiving configuration information for a measurement object secondary link for a secondary base station with the user device upon establishment by the user device of a dual connection mode wherein the user device is served by the primary base station and the secondary base station; and
controlling the user device to use a secondary link measurement object to report link information relating to the secondary link in response to occurrence of a triggering event while the user device is operating in the dual connection mode.

30. The method of claim 29, further comprising limiting the user device to measuring frequencies within at least one defined frequency group, upon occurrence of a triggering event when the user device is in a dual connection mode.

31. The method of claim 29, further comprising, controlling the user device, when the user device is operating in a dual connection mode, to report link information upon the recognition of a triggering event relating to at least one frequency in at least one specified frequency group.

32. The method of claim 29, wherein the primary link is a link between a user device and a macro base station and the secondary link is a link between a user device and a local area base station.

33. The method of claim 29, wherein the primary link is a link between a user device and a local area base station and the secondary link is a link between a user device and a macro base station.

34. The method of claim 29, wherein the user device is a mobile phone.

35. The method of claim 29, wherein the device is a user equipment.

36. The method of claim 35, wherein the user equipment is a mobile phone.

37-44. (canceled)

45. A non-transitory computer readable medium storing a program of instructions, execution of which by a processor configures an apparatus to at least:
receive configuration information for a measurement object information element for a primary link with a user device served by a primary base station of a wireless network;
receive configuration information for a secondary link measurement object for a secondary base station with the user device upon establishment by the user device of a dual connection mode wherein the user device is served by the primary base station and the secondary base station; and
control the user device to use the secondary link measurement object to report link information relating to the secondary link in response to occurrence of a triggering event while the user device is operating in the dual connection mode.

46. The computer readable medium of claim 45, wherein execution of the program of instructions by a processor further causes the apparatus to limit the user device to measuring frequencies within at least one defined frequency group, upon occurrence of a triggering event when the user device is in a dual connection mode.

47-60. (canceled)
